(19) United States
(12) Patent Application Publication
(10) Pub. No.: US 2013/0332395 A1
(43) Pub. Date: Dec. 12, 2013

(54) SYSTEM AND METHOD FOR MANAGING CONTENTS PRICE

(71) Applicants: Chul-woo KIM, Seoul (KR); Hye-jeong YUN, Seoul (KR)

(72) Inventors: Chul-woo KIM, Seoul (KR); Hye-jeong YUN, Seoul (KR)

(73) Assignee: KT CORPORATION, Seongnam-city (KR)

(21) Appl. No.: 13/492,196

(22) Filed: Jun. 8, 2012

(51) Int. Cl. G06Q 30/00

(52) U.S. Cl. 705/400

(57) ABSTRACT

A contents price managing method includes providing contents information including a contents price to a first device; if contents corresponding to the provided contents information is output using the first device, calculating a contents usage fee for the first device based on the contents price and an output length of the contents that is output through the first device. The method may further include updating the contents price based on the output length of the contents; and providing contents information including the updated contents price to a second device.

### BACKGROUND

1. Field

Exemplary embodiments broadly relate to a system and a method for managing a contents price, and more specifically, exemplary embodiments relate to a system and a method for managing a contents price by updating the contents price based on the amount of contents provided.

2. Description of the Related Art

With recent development of communications technology and rapid propagation of the Internet, various services have been provided to users via the Internet. In particular, IPTV services that provide various contents to users via Internet networks have come into wide use.

A user may be supplied with various contents, particularly, VOD (Video On Demand) contents.

The VOD contents may be provided to the user via a device upon request. In a related art, such VOD contents have been provided for free or at a predetermined charge.

According to a related art method, if the user selects contents, a predetermined price for the selected contents is charged to the user regardless of whether or not the user actually watches the whole contents.

Therefore, according to the related art method, there may be a gap between a VOD contents supply price and a price desired by the user. That is, the user may have paid for contents, he or she did not really watch or watched only partially. Thus, the user may have complaints with the service. For example, if the contents is purchased for a predetermined period of time and the user could not complete watching the contents in this time period, the user may be forced to pay twice, which would result in user frustration with the service.

### SUMMARY

Accordingly, it is an aspect to provide a method and a system for charging a fee to a user based on the amount of contents actually output.

Another aspect is to provide a method and a system for measuring market evaluation, i.e., popularity of contents and popularity trends and reflecting the measured popularity trends in update of a contents price to thereby reasonably provide contents by increasing a price of a popular contents and relatively decreasing a price of a less-popular contents.

According to an aspect of exemplary embodiments, there is provided a method of managing a contents price. The method includes providing contents information including a contents price to a first device, if contents corresponding to the provided contents information is output using the first device, calculating a contents usage fee for the first device based on the contents price and an output length of the contents, and providing the calculated contents usage fee to at least one of the first device and another device. The method may further include updating the contents price based on the output length of the contents, and providing the contents information including the updated contents price to a second device.

According to another aspect of exemplary embodiments, a contents sales management server includes a contents price providing unit configured to provide a device with a contents price, a contents usage fee calculation unit configured to calculate a contents usage fee for the device based on an output length of the contents output using the device. The contents price providing unit is further configured to provide the calculated contents usage fee to at least one of the device and another device. The contents sales management server may further include a contents price update unit configured to update the contents price based on the output length of the contents output using the device. The contents price providing unit may further be configured to provide another device with the updated contents price.

In exemplary embodiments, a contents usage fee is calculated based on the amount of contents output and the calculated contents usage fee is charged to the user. That is, whether the user watches the whole contents or stops watching the contents is reflected in the calculation of a contents usage fee and the calculated contents usage fee is charged to the user. Thus, the user's complaints caused by a charge of a predetermined price may be solved.

Further, an aspect of exemplary embodiments may provide a popularity trend based on a variation in the amount of contents provided is reflected in an update of a contents price. Thus, a contents price with a market evaluation of contents reflected therein may be suggested to the user. Also, the user may be provided with objective information helpful to the user to select good-quality contents.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 is a view illustrating a configuration of a contents price management system according to an exemplary embodiment;

FIG. 2 is a flow diagram illustrating a contents price management method according to an exemplary embodiment; and

FIG. 3 is a block diagram illustrating a contents sales management server according to an exemplary embodiment.

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote like parts throughout the whole document.

Throughout the whole document, the terms “connected to” or “coupled to” are used to designate a connection or coupling of one element to another element, and include both a case where an element is “directly connected or coupled to” another element and a case where an element is “electronically connected or coupled to” another element via still another element. Further, each of the terms “comprises,” “includes,” “comprising,” and “including,” as used in the present disclosure, is defined such that one or more other components, steps, operations, and/or the existence or addition of elements are not excluded in addition to the described components, steps, operations and/or elements.

Hereinafter, exemplary embodiments will be explained in detail with reference to the accompanying drawings.

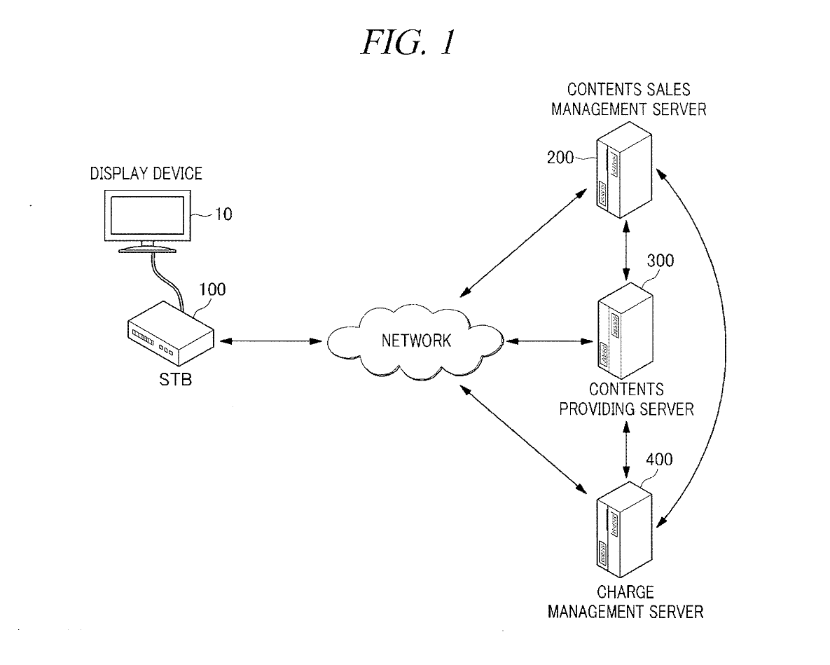

FIG. 1 is a view illustrating a configuration of a contents price management system according to an exemplary embodiment.

According to an exemplary embodiment, a device such as a set-top box 100 is provided with a multimedia service such as an IPTV service from an IPTV service provider and is provided with contents from a contents providing server 300 through the IPTV service.

The set-top box 100 receives, from a contents sales management server 200, a list of contents, which may be provided through the IPTV service. The list of contents includes a plurality of contents information and each of the contents information may include a contents price. The contents price may be charged to the user when a predetermined amount of the contents is provided.

The set-top box 100 outputs the received list of contents on a display device 10, such as a TV connected to the set-top box 100 and receives an input for selecting specific contents included in the list of contents via the display device 10. The selection may be input by a user using a user input device such as a remote control, a keyboard, a mouse, and so on.

The set-top box 100 transmits a request for the selected contents to the contents sales management server 200. The set-top box 100 receives the requested contents from the contents providing server 300 and provides it using the display device 10.

The contents sales management server 200 updates a contents price and provides the list of contents including the contents information to the set-top box 100.

The contents sales management server 200 updates the contents price based on contents usage information, i.e., an output length including reproducing time or a number of frames of the provided contents. Further, the contents sales management server 200 measures a popularity trend of the provided contents based on an output length of the provided contents and updates the price of the provided contents based on the measured popularity trend. Exemplary updates of the price of the provided contents will be explained in greater detail below.

The contents sales management server 200 receives a request for contents from the set-top box 100 and transmits the received request to the contents providing server 300 that provides the requested contents. The contents sales management server 200 may transmit, to the contents providing server 300, identification information with the request for the contents. The identification information may include at least one of identification information of the contents, identification information of the set-top box 100 and identification information of a user of the set-top box 100.

The contents sales management server 200 receives, from the contents providing server 300, contents usage information, i.e., an output length including reproducing time or a number of frames of contents provided by the set-top box 100. The contents sales management server 200 determines a contents usage fee to be charged to the user of the set-top box 100 according to the received contents usage information and generates charge information. Further, the contents sales management server 200 transmits the generated charge information to a charge management server 400.

The contents sales management server 200 updates the price of the contents according to the received contents usage information. Thereafter, based on the use of the contents, the contents sales management server 200 performs all of the operations based on the updated price of the contents.

In response to the request received from the contents sales management server 200, the contents providing server 300 provides the requested contents to the set-top box 100 corresponding to the identification information received together with the request for the contents.

When the set-top box 100 stops output of the contents, the contents providing server 300 receives a stopping signal indicating that the output of the contents has stopped from the set-top box 100. Based on the received stopping signal, the contents providing server 300 generates contents usage information, i.e., an output length including reproducing time or a number of frames of the contents provided by the set-top box 100 and transmits the generated contents usage information to the contents sales management server 200.

The charge management server 400 transmits the charge information received from the contents sales management server 200 to the set-top box 100. In an exemplary embodiment, the contents providing server 300 and the contents sales management server 200, and the charge management server 400 may communicate using a public network such as the Internet or via an internal network wired or wireless network such as local access network.

In an exemplary embodiment, although it has been described that the set-top box 100 transmits the request for the contents to the contents providing server 300 through the contents sales management server 200, this is provided by way of an example only and not by way of a limitation. For example, the set-top box 100 may transmit the request for the contents directly to the contents providing server 300.

Further, in an exemplary embodiment, although it has been described that the contents sales management server 200 generates charge information upon output of contents and transmits the generated charge information to the charge management server 400, this is provided by way of an example only and not by way of a limitation. For example, the charge management server 400 may generate the charge information based on the content price updated by the contents sales management server 200 and the contents usage information received from the contents providing server 300.

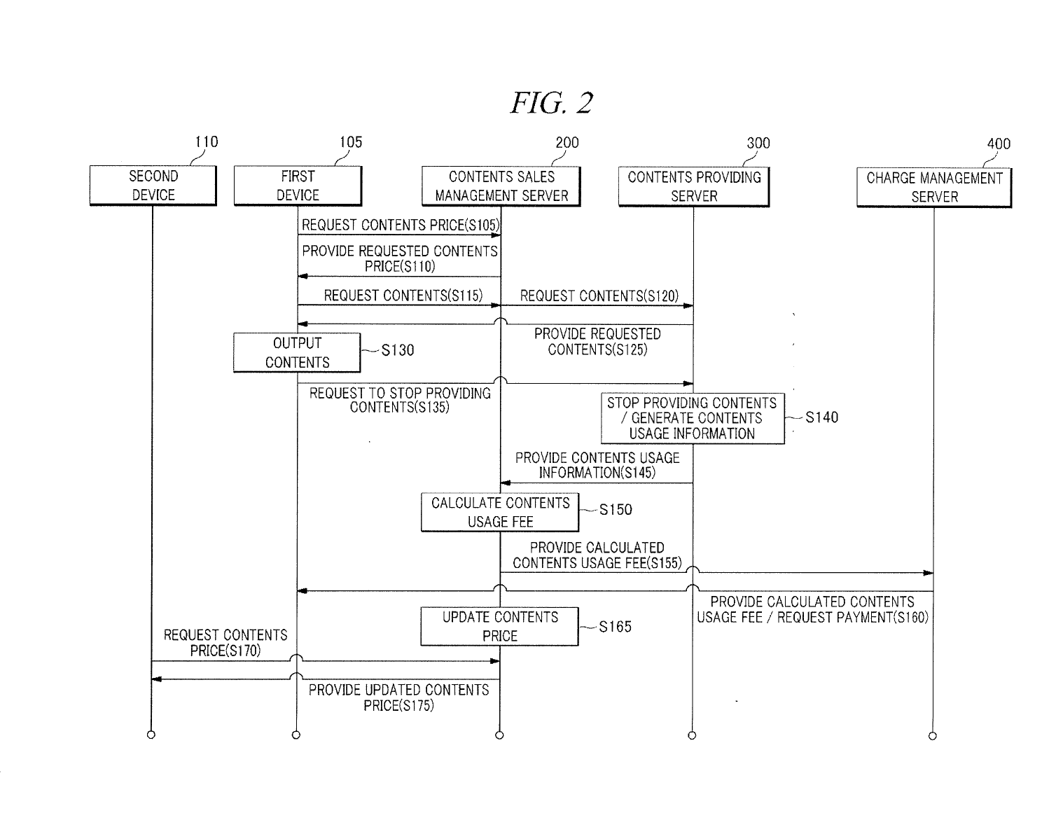

FIG. 2 is a flow diagram illustrating a contents price management method according to an exemplary embodiment.

In operation S105, a first device 105, for example, a set-top box (STB), requests a contents price from the contents sales management server 200. The first device 105 may request contents information about the contents to be provided through the IPTV service with the contents price.

In operation S110, the contents sales management server 200 provides the requested contents price to the first device 105.

The contents sales management server 200 may also provide the requested contents information along with the provided contents price to the first device 105.

An initial contents price may be determined by the IPTV service provider or by a contents provider. By way of example, the initial contents price may be set to $0 dollars, so that the contents may be provided for free to a predetermined number of users as a promotional offer.

In operation S115, the first device 105 requests the contents corresponding to the received contents price from the contents sales management server 200.

The first device 105 may transmit identification information to the contents sales management server 200 to request the contents. The identification information may include at least one of identification information of the contents, identification information of the first device 105 and identification information of a user of the first device 105.

In operation S120, in response to the request for the contents received in operation S115, the contents sales management server 200 transmits, to the contents providing server 300, the identification information, and the request for the contents. The contents sales management server 200 may make a request to the contents providing server 300 to provide the contents to the first device 105.

In operation S125, the contents providing server 300 provides the requested contents to the first device 105 in response to the request for the contents received in operation S120.

In operation 5130, the first device 105 outputs the contents provided in operation S125 through a display device 10 (not illustrated), such as a TV, connected to the first device 105 to provide the contents.

In operation 5135, the first device 105 receives an input requesting to stop the output of the contents and transmits the request to stop providing the contents to the contents providing server 300. The display device 10 may output a part or all of the contents provided to the first device 105.

By way of example, the user may be interested in the provided contents and may use the contents until it is finished. On the contrary, the user may be bored with the provided contents and may stop output of the contents.

In operation 5140, the contents providing server 300 may stop providing the contents in response to the request to stop providing the contents received in operation 5135. Upon stopping to provide the contents, the contents providing server 300 generates contents usage information, i.e., an output length of the contents provided by the first device 105. The output length of the contents includes reproducing time and/or a number of output frames of the contents.

In operation S145, the contents providing server 300 transmits the contents usage information generated in operation S140 to the contents sales management server 200.

In operation 5150, the contents providing server 300 calculates a contents usage fee to be charged to the user of the first device 105 based on the contents usage information received in operation S145 and the contents price provided to the first device 105 in operation S110.

By way of example, the contents providing server 300 may calculate the contents usage fee by using the following equation 1.

$$Contents usage fee = \frac{Output length of the contents}{Total length of the contents} \times Contents price \qquad [ Equation 1 ]$$

That is, the contents providing server 300 does not calculate the contents usage fee as the contents price but calculates the contents usage fee by multiplying the contents price by a ratio of an output length of the contents to a total length of the contents.

Therefore, the contents usage fee is calculated based on the amount of contents actually provided.

By way of example, in case of a video contents, if the user have other things to do while watching the video contents or the user is not interested in the video contents, a user may stop watching the video contents and pay a fee for the amount of contents actually watched instead of paying a whole fee for the whole contents.

In operation S155, the contents sales management server 200 transmits the contents usage fee calculated in operation S150 to the charge management server 400.

In operation 5160, the charge management server 400 transmits the contents usage fee received in operation S155 to the first device 105 to request payment of the contents usage fee.

In operation S165, the contents sales management server 200 updates the contents price based on the contents usage information.

The contents sales management server 200 calculates a popularity trend of the contents and updates the contents price based on the calculated popularity trend. The contents sales management server 200 may calculate the popularity trend of the contents by using the following equations 2 to 4.

$$\begin{matrix}Popularity trend = \frac{Recent popularity}{Total popularity} & [ Equation 2 ] \\ Recent popularity = \frac{\begin{matrix}Average output length of \\ the contents by recent devices\end{matrix}}{Total length of the contents} & [ Equation 3 ]\end{matrix}$$

The recent devices may include a predetermined number of devices or devices corresponding to a predetermined percentage of total devices.

$$Total popularity = \frac{\begin{matrix}Average output length of \\ the contents by total devices\end{matrix}}{Total length of the contents} \qquad [ Equation 4 ]$$

As described above, the contents sales management server 200 may calculate a ratio of an average output length of the contents through a predetermined percentage of recent devices, for example, about 10% of total devices, to an average output length of the contents through the total devices as a popularity trend of the contents.

Therefore, the contents sales management server 200 may calculate how much the recent devices among the total devices output the contents to calculate the popularity trend of the contents.

The contents sales management server 200 may update the contents price by adding or subtracting a predetermined charge to/from a previous contents price based on the calculated popularity trend of the contents.

By way of example, if the popularity trend of the contents is greater than “1”, the contents sales management server 200 may increase the contents price by adding a predetermined charge, for example, about 10 cents, to the previous contents price.

If the popularity trend of the contents is smaller than “1”, the contents sales management server 200 may decrease the contents price by subtracting the predetermined charge from the previous contents price.

Therefore, if an amount of contents provided is recently increased or decreased, the contents sales management server 200 may increase or decrease the contents price accordingly.

Further, the contents sales management server 200 presets a maximum price. Even if the recent popularity is increased, the contents sales management server 200 may control a contents price so as not to exceed the preset maximum price.

In operation S170, a second device 110 requests contents price from the contents sales management server 200. In an analogous manner as the first device 105, the second device 110 may request the contents price to be provided through the IPTV service with a list of contents.

In operation S175, the contents sales management server 200 provides the updated contents price updated in operation S165 to the second device 110 in response to the request for the contents price received in operation S170. Thus, the second device 110 may be provided with the updated contents price reflecting the contents usage information of the first device 105.

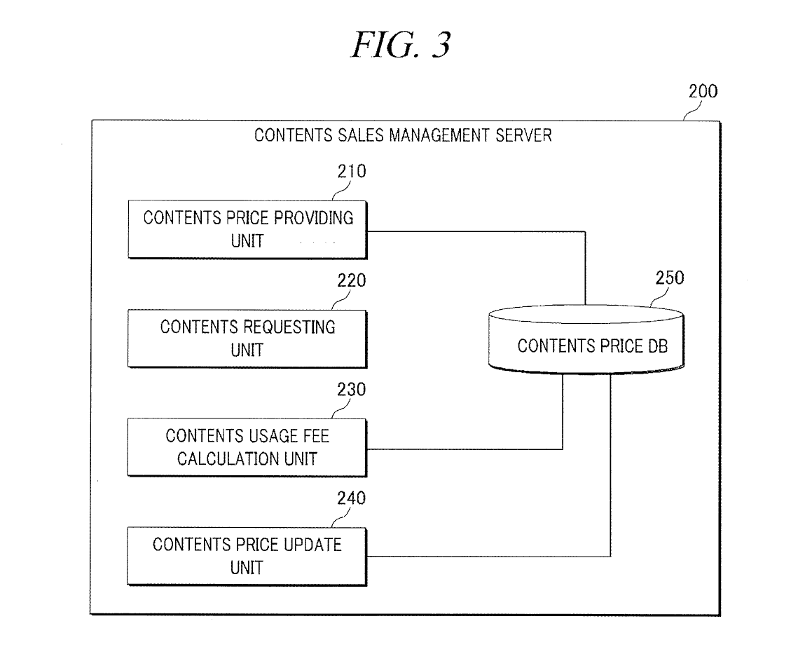

FIG. 3 is a block diagram illustrating a configuration of a contents sales management server according to an exemplary embodiment.

The contents sales management server 200 according to an exemplary embodiment includes a contents price providing unit 210, a contents requesting unit 220, a contents usage fee calculation unit 230, a contents price update unit 240, and a contents price database (DB) 250.

The contents price providing unit 210 provides a device (not illustrated) with a contents price indicating a price for viewing the contents by the device in response to a request for the contents price from the device.

The contents price provided by the contents price providing unit 210 is updated by the contents price update unit 240 or initially set by a contents provider or an IPTV service provider.

The contents price update unit 240 stores the contents price in the contents price database 250.

The contents requesting unit 220 receives a request for contents from a device. In response to the received request for the contents, the contents requesting unit 220 transmits identification information with the request for the contents to a contents providing server (not illustrated). The contents providing server that receives the identification information from the contents requesting unit 220 may provide the requested contents to the device by using the received identification information. The identification information may include at least one of identification information of the contents, identification information of the first device 105 and identification information of a user of the first device 105.

The contents usage fee calculation unit 230 calculates a contents usage fee to be charged to the user of the device based on contents usage information, from the contents providing server, i.e., an output length of the contents actually provided by the device. The output length of the contents may include reproducing time or a number of frames of the contents.

As described above, in an exemplary embodiment, the contents usage fee may be calculated by applying a ratio of an output length of the contents provided by the device to a total length of the contents to the contents price stored in the contents price database 250 by using exemplary equation 1 described above.

The contents price update unit 240 updates the contents price based on contents usage information of the device received from the contents providing server.

As described above, in an exemplary embodiment, the contents price update unit 240 calculates a popularity trend of the contents, i.e., an increasing or a decreasing trend for providing the contents by recent devices by using the exemplary equations 2 to 4. The contents price update unit 240 may update the contents price reflecting content usage information of the recent devices by adding or subtracting a predetermined charge to/from a previous contents price based on the calculated popularity trend of the contents.

In an exemplary embodiment, the recent devices may include a predetermined number of devices or devices corresponding to a predetermined percentage of total devices.

The contents price update unit 240 stores the updated contents price in the contents price database 250.

Exemplary embodiments may be embodied in a transitory or non-transitory storage medium which includes instruction codes which are executable by a computer or processor, such as a program module which is executable by the computer or processor. A data structure according to exemplary embodiments may be stored in the storage medium and executable by the computer or processor. A computer readable medium may be any usable medium which can be accessed by the computer and includes all volatile and/or non-volatile and removable and/or non-removable media. Further, the computer readable medium may include any or all computer storage and communication media. The computer storage medium may include any or all volatile/non-volatile and removable/non-removable media embodied by a certain method or technology for storing information such as, for example, computer readable instruction code, a data structure, a program module, or other data. The communication medium may include the computer readable instruction code, the data structure, the program module, or other data of a modulated data signal such as a carrier wave, or other transmission mechanism, and includes information transmission mediums.

The above description of exemplary embodiments is provided for the purpose of illustration, and it will be understood by those skilled in the art that various changes and modifications may be made without changing a technical conception and/or any essential features of the exemplary embodiments. Thus, above-described exemplary embodiments are exemplary in all aspects, and do not limit the present disclosure. For example, each component described to be of a single type can be implemented in a distributed manner. Likewise, components described to be distributed can be implemented in a combined manner.

The scope of the present inventive concept is defined by the following claims and their equivalents rather than by the detailed description of exemplary embodiments. It shall be understood that all modifications and embodiments conceived from the meaning and scope of the claims and their equivalents are included in the scope of the present inventive concept.

What is claimed is:

1. A method of managing a contents price, the method comprising:
providing contents information comprising a contents price to a first device;
if contents corresponding to the provided contents information is output using the first device, calculating a contents usage fee for the first device based on the contents price and an output length of the contents; and
providing the calculated contents usage fee to at least one of the first device and another device.

2. The method of claim 1, further comprising:
updating the contents price based on the output length of the contents; and
providing the contents information comprising the updated contents price to a second device,

3. The method of claim 1, wherein the contents usage fee for the first device is calculated based on a ratio of the output length of the contents to a total length of the contents.

4. The method of claim 2, wherein the contents price is updated based on a popularity trend that is a ratio of an average output length of the contents output using devices that recently viewed the contents to an average output length of the contents output using devices that viewed the contents, and
wherein the devices that recently viewed the contents comprise a predetermined number of devices comprising the first device.

5. The method of claim 4, wherein the updating the content price comprises, if the popularity trend is greater than 1, increasing the contents price.

6. The method of claim 4, wherein the updating the content price comprises, if the popularity trend is smaller than 1, decreasing the contents price.

7. A contents sales management server comprising:
a contents price providing unit configured to provide a device with a contents price; and
a contents usage fee calculation unit configured to calculate a contents usage fee for the device based on an output length of the contents that is output using the device,
wherein the contents price providing unit is further configured to provide the calculated contents usage fee to at least one of the device and another device.

8. The content sales management server of claim 7, further comprising:
a contents price update unit configured to update the contents price based on the output length of the contents output using the device,
wherein the contents price providing unit is further configured to provide a second device with the updated contents price.

9. The server of claim 7, wherein the contents usage fee of the device is calculated based on a ratio of the output length of the contents to a total length of the contents.

10. The server of claim 8, wherein the contents price update unit is further configured to update the contents price based on a popularity trend that is a ratio of an average output length of the contents output using devices that recently viewed the contents to an average output length of the contents output using devices that viewed the contents, and
the recent devices comprise a predetermined number of devices comprising the first device.

11. The server of claim 7, wherein the output length of the contents comprises one of reproducing time and a number of frames of the contents.

12. The server of claim 10, wherein the contents price update unit is further configured to update the contents price based on a ratio of recent popularity trend to a total popularity trend, wherein the recent popularity trend comprises a ratio of an average output length of the contents output using devices that recently viewed the contents to a total length of the contents and wherein the total popularity trend comprises a ratio of an average output length of the contents output using devices that viewed the contents to the total length of the contents.

13. The method of claim 1, further comprising: stopping the output of the contents using the first device; and calculating the output length based on a starting position which indicates starting the output of the contents and based on the stopping the output of the contents.

14. A non-transitory computer readable medium storing computer-executable instructions which implement the method of claim 1.
